(19) United States
(12) Patent Application Publication
(10) Pub. No.: US 2004/0042224 A1
(43) Pub. Date: Mar. 4, 2004

(54) Exhaust pipe with light and sound effect

(76) Inventor: Kuo-Tai Chen, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/229,094

(22) Filed: Aug. 28, 2002

(51) Int. Cl. B60Q 1/00

(52) U.S. Cl. 362/487

(57) ABSTRACT

An exhaust pipe with light and sound effect comprises an inner tube, an outer tube rear section, an outer tube front section, a circuit board, light emitting diodes, a retaining ring and a lamp shield, wherein the inner tube is connected to the inside of the outer tube rear section which has one end connected to the outer tube front section, the circuit board comprises a number of light emitting diodes with the same or different colors, and is wrapped in the lamp shield, the outer tube front section has a reduced end and a groove for the lamp shield and the retaining ring to secure thereto, the control circuit of the light emitting diodes controls the lighting and sound effect.

### FIELD OF THE INVENTION

This invention relates to an exhaust pipe, and more particularly, to an exhaust pipe with colorful lighting and music effect.

### BACKGROUND OF THE INVENTION

One of the conventional exhaust pipes on the market comprises neon light tubes to light the exhaust pipe, which uses an inner tube connected and secured to the tail of the exhaust pipe and the inner tube is then secured in an outer tube, which is designed to have neon light tubes on its outer surface, the neon light tubes are kept in a distance from the inner tube that allows air to flow through there, whereas the air flows through the space between the inner tube and the outer tube meeting with the exhaust gas produces turbulence. When the light projects onto the turbulence, the light also goes with the turbulence, thus produces a floating neon light.

However, the neon light tubes are easy to break during shipping, storage, and are a bit complicated to install.

### SUMMARY OF THE INVENTION

It is the primary object of the present invention to provide an exhaust pipe with light and sound effect, which is easy to install and to take apart.

It is another object of the present invention to provide an exhaust pipe with light and sound effect, which is more colorful and more attractive.

It is a further object of the present invention to provide an exhaust pipe with light and sound effect, which is more solid and easy to replace.

### BRIEF DESCRIPTION OF THE DRAWINGS

FIG. 1 is an exploded view of the present invention;

FIG. 2 is an enlarged sectional view taken along circle 2 of FIG. 1;

FIG. 3 is a side sectional view of the present invention;

FIG. 4 is an enlarged view of circle 4 of FIG. 3; and

FIG. 5 is a side sectional view of a second embodiment of the present invention.

### DETAILED DESCRIPTION OF THE PREFERRED EMBODIMENTS

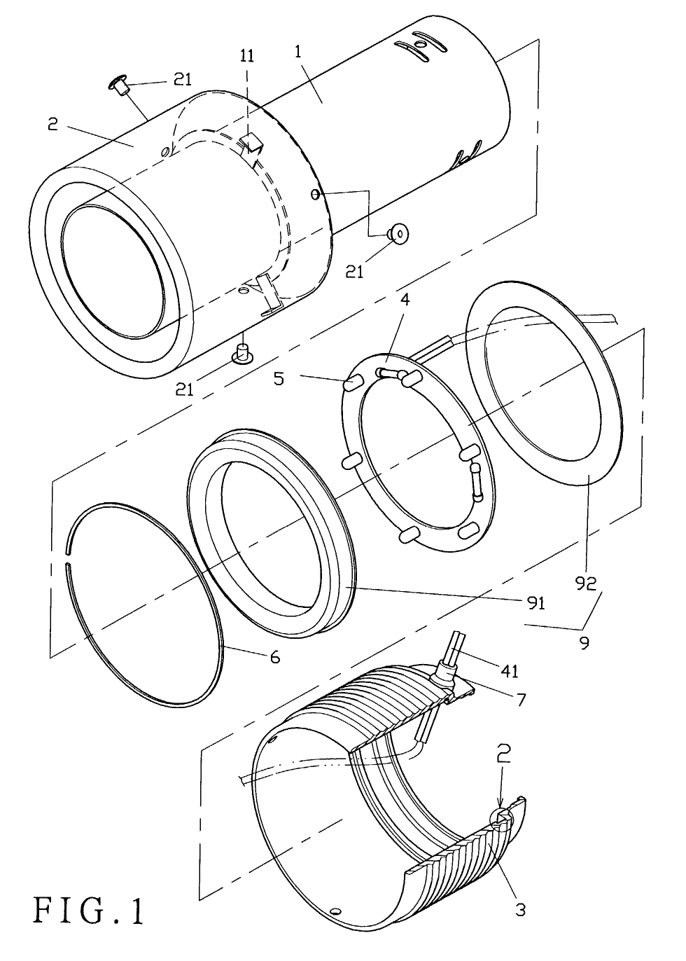

An exhaust pipe with light and sound effect comprises an inner tube 1, an outer tube rear section 2, an outer tube front section 3, a circuit board 4, a plurality of light emitting diodes 5, a retaining ring 6, an insulating sleeve 7, water proof glue 8 and a lamp shield 9, as shown in FIG. 1.

The inner tube 1 is secured to the outer tube rear section 2 with fixtures 11, and maintains a space from the outer tube rear section 2, the front end of the outer tube rear section 2 corresponding to the front end of the inner tube 1 is secured with the outer tube front section 3 and fastened by rivets 21.

The circuit board 4 comprises a number of light emitting diodes 5 on one side thereof, and is wrapped by the lamp shield 9. The lamp shield 9 is formed with a front shield 91 and a rear shield 92 to cover both the circuit board 4 and the light emitting diodes 5. The lamp shield 9 has a hole for an electric wire 41 from the circuit board 4 to extend there through.

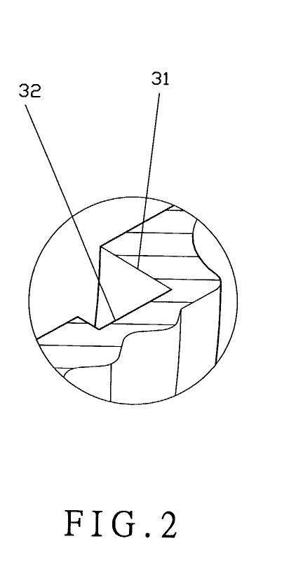

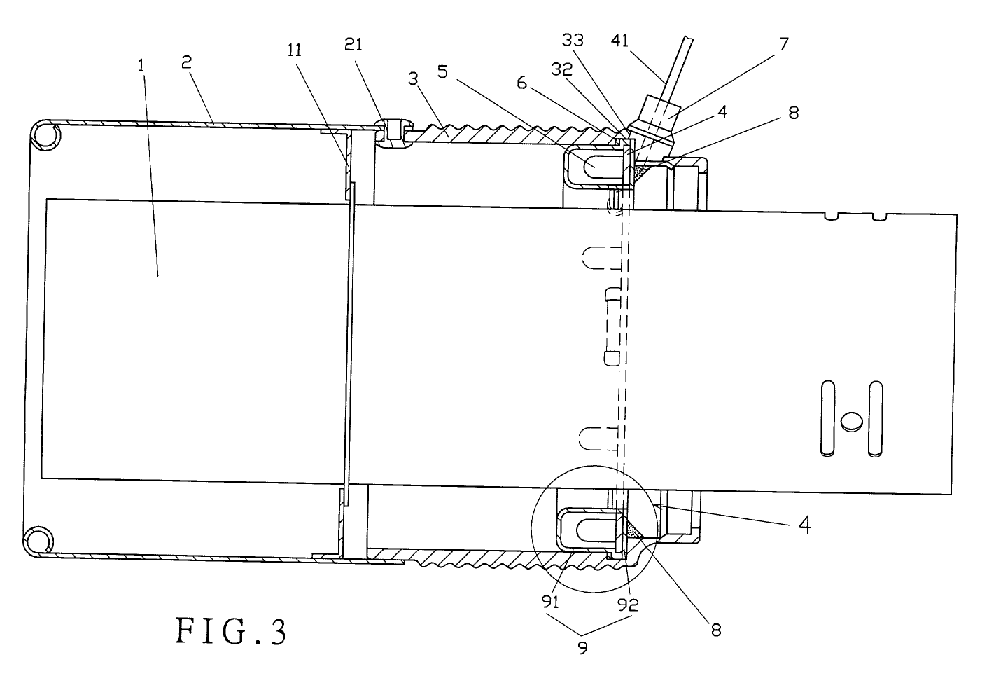

The outer tube front section 3, as shown in FIG. 2, comprises a reduced end forming a step surface 31 at the inner portion of the reduced end for positioning of the lamp shield 9, a groove 32 is formed next to the step surface 31 to position the retaining ring 6 therein. The outer tube front section 3 further comprises a hole 33, as shown in FIG. 3, for an insulating sleeve 7 to insert there through and the electric wire 41 to go through the insulating sleeve 7 and extend outwardly, the electric wire 41 is then connected to a control circuit, which will not be described hereinafter, to control conduction of the light emitting diodes 5.

Further, the control circuit may be pre-programmed to control conduction of the light emitting diodes S by means of gears, speed or RPM of the vehicle to vary the lights when the vehicle is moving. This lighting device may also be treated as a warning signal when the engine is in idle status. The control circuit may also control a sound system at the same time.

The circuit board 4 equipped with various colors of light emitting diodes 5, is placed in the outer tube front section 3, against the step surface 31, and the retaining ring 6 is placed in the groove 32 of the outer tube front section 3 and engages with the circuit board 4, so that the circuit board 4 is secured by the step surface 31 and the retaining ring 6 at place. The outer tube front section 3, at this moment, may be connected and secured with the outer tube rear section 2 by the rivets 21, this completes the installation of the present invention.

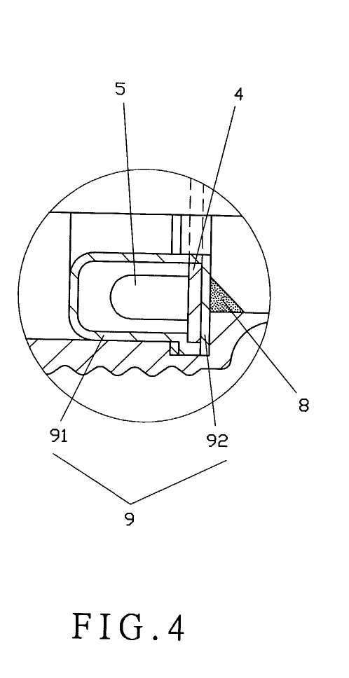

In order to prevent water or humid from entering the circuit board 4 and the light emitting diodes 5, the connecting area between the lamp shield 9 and the step surface 31 may be applied with the water proof glue 8, as shown in FIG. 4.

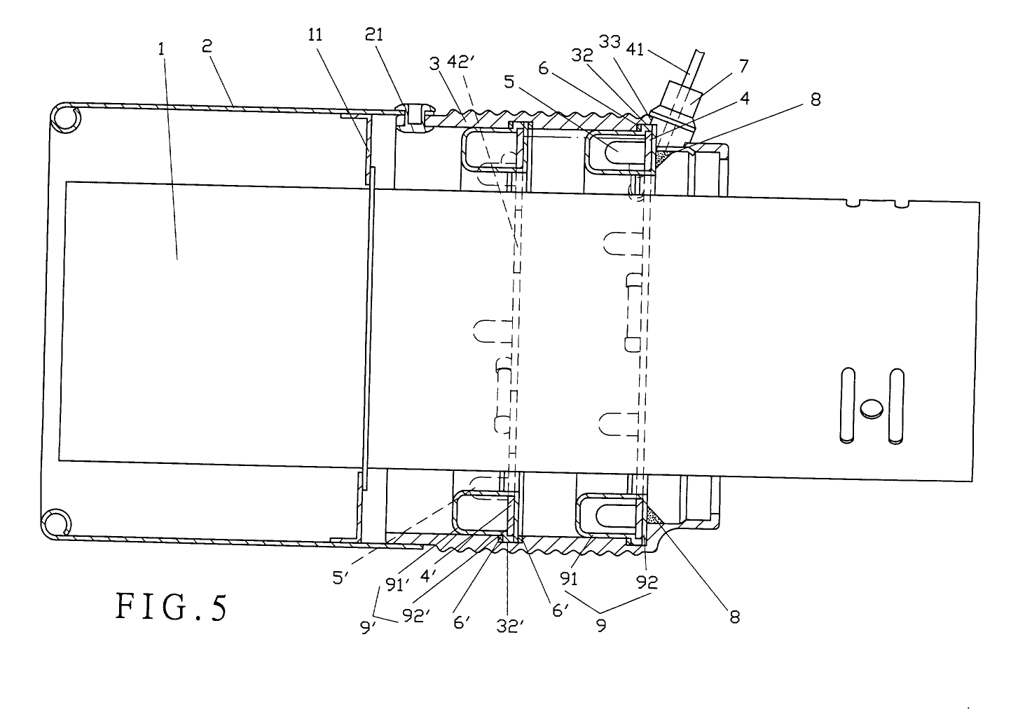

According to the previous description of the present invention, there is only a single circuit board is applied, the other embodiment may have two circuit boards 4 and 4′, two sets of light emitting diodes 5 and 5′ and two sets of retaining ring 6 and 6′, as shown in FIG. 5. Although this design has double many of the parts, the design still remains the same. This design provides more colorful lighting and sound effect.

I claim:

1. An exhaust pipe with light and sound effect, comprising an inner tube, an outer tube rear section, an outer tube front section, a circuit board, light emitting diodes, a retaining ring and a lamp shield, wherein said inner tube being secured to said outer tube rear section with a space left in between, said outer tube rear section having one end corresponding to said inner tube secured to said outer tube front section, said circuit board being secured in between said inner tube and said outer tube front section, and being characterized in that,
said circuit board having equipped with light emitting diodes with the same or different colors, said circuit board and said light emitting diodes being wrapped by a transparent lamp shield, said outer tube front section comprising a reduced section forming a step surface thereat for said lamp shield to stay against thereto, whereas a groove being formed next to said step surface for positioning a retaining ring to secure said lamp shield at place, said outer tube front section comprising a hole for an electric wire from said circuit board to extend there through, and said lamp shield engaging with said step surface being applied with water proof glue.

2. The exhaust pipe with light and sound effect, as recited in claim 1, wherein said lamp shield comprises a front shield and a rear shield.

3. The exhaust pipe with light and sound effect, as recited in claim 1, wherein said light emitting diodes are preprogrammed to control its conductibility by means of gears, speed, RPM of an vehicle.

4. The exhaust pipe with light and sound effect, as recited in claim 1, wherein said program controls a sound system.

5. The exhaust pipe with light and sound effect, as recited in claim 1, wherein at least two sets of circuit boards are adapted.
